(19) United States
(12) Patent Application Publication
(10) Pub. No.: US 2024/0343443 A1
(43) Pub. Date: Oct. 17, 2024

(54) WHEELCHAIR AND ELECTRIC WHEELCHAIR AND MOBILITY AIDE TRANSPORT WEIGHT DISTRIBUTION PAN FOR AIRCRAFT CARGO HOLD

(71) Applicant: William J. Boyer, JR., Lakewood, WA (US)

(72) Inventor: William J. Boyer, JR., Lakewood, WA (US)

(21) Appl. No.: 18/409,705

(22) Filed: Jan. 10, 2024

Related U.S. Application Data
(60) Provisional application No. 63/479,489, filed on Jan. 11, 2023.

(51) Int. Cl. B65D 19/06; B65D 85/68

(52) U.S. Cl. CPC B65D 19/06; B65D 85/68

(57) ABSTRACT

A mobility aide transport assembly for use in a cargo hold of a transport vehicle. The assembly has a base panel, sidewalls coupled to the base panel and shaped to extend adjacent and substantially parallel to wall panels of the cargo hold, and end walls coupled to the base panel and extending between the sidewalls. At least one of the end walls has a ramp configuration sloping downwardly from the top portion to the bottom portion of the base panel. Tie down anchors are recessed in the top portion of the base panel and are configured to releasably engage tiedown strap connected to the mobility aide to fixedly retain the mobility aide atop the base panel. Other tie down anchors are recessed in the top portion of the base panel and configured to be coupled to floor anchor members of the cargo hold. Handles are recessed in the top portion of base panel and configured to be engaged by a user to position the base panel relative to the cargo hold's floor panels. The assembly holds the mobility aid is a fixed position on the base panel, and the base panel distributes weight of the mobility aide transport across the area of the panels bottom portion for reduction of the load (lbs/ft²) to the cargo hold's floor panels.

### CROSS-REFERENCE TO RELATED APPLICATION

This non-provisional patent application claims priority to and the benefit of U.S. Provisional Patent Application No. 63/479,489, titled Aircraft Cargo Floor Weight Distribution Pan, filed Jan. 11, 2023, which is incorporated herein in its entirety by reference thereto.

### TECHNICAL FIELD

The application relates to a cargo assembly for an aircraft cargo area.

### BACKGROUND

Heavy cargo loaded into the cargo area of an aircraft or transport vehicle can apply forces (lbs./ft²) to the floor panels of the cargo area that exceed permissible load limitations. There is a need to transport cargo, particularly heavy electric wheelchairs, scooters, or other mobility aides or heavy cargo items, that does not exceed permissible load limitations of the transport vehicle's cargo area floor.

### BRIEF DESCRIPTION OF THE DRAWINGS

Features, aspects, and advantages of the presently disclosed technology may be better understood with regard to the following drawings.

FIG. 1 is a perspective view of a rigid transport assembly for use in the cargo area of an aircraft or other cargo transport vehicle in accordance with one or more embodiments of the present technology.

FIG. 2 is a perspective view of the transport assembly of FIG. 1 positioned on the floor of an aircraft's cargo area.

FIG. 3 is a perspective view of the transport assembly of FIG. 2 positioned on the floor of an aircraft's cargo area and with a heavy mobility aide item secured to the assembly in accordance with one or more embodiments of the present technology.

FIG. 4 is a perspective view of a transport assembly for use in the cargo area of an aircraft or other cargo transport vehicle in accordance with one or more embodiments of the present technology.

FIG. 5 is a perspective view of the transport assembly of FIG. 4 positioned on the floor of an aircraft's cargo area.

FIG. 6 is a perspective view of the transport assembly of FIG. 4 positioned on a floor with a heavy mobility aide secured to the assembly in accordance with one or more embodiments of the present technology.

FIG. 7 is a perspective view of a transport assembly for use in the cargo area of an aircraft or other cargo transport vehicle in accordance with one or more embodiments of the present technology.

FIG. 8 is a bottom perspective view of the transport assembly of FIG. 7.

FIG. 9 is an enlarged perspective view of a portion of the transport assembly of FIG. 7.

FIG. 10 is a perspective view of the transport assembly of FIG. 7 with a cover over a heavy mobility aide strapped atop the transport assembly and.

FIG. 11 is a perspective view of the transport assembly of FIG. 7 with supplemental handles and with a heavy mobility aide strapped atop the transport assembly.

FIG. 12 is a perspective view of the transport assembly of FIG. 11 with a cover over a mobility aide supported on the transport assembly.

A person skilled in the relevant art will understand that the features shown in the drawings are for purposes of illustration, and variations, including different and/or additional features and arrangements thereof, are possible.

### DETAILED DESCRIPTION

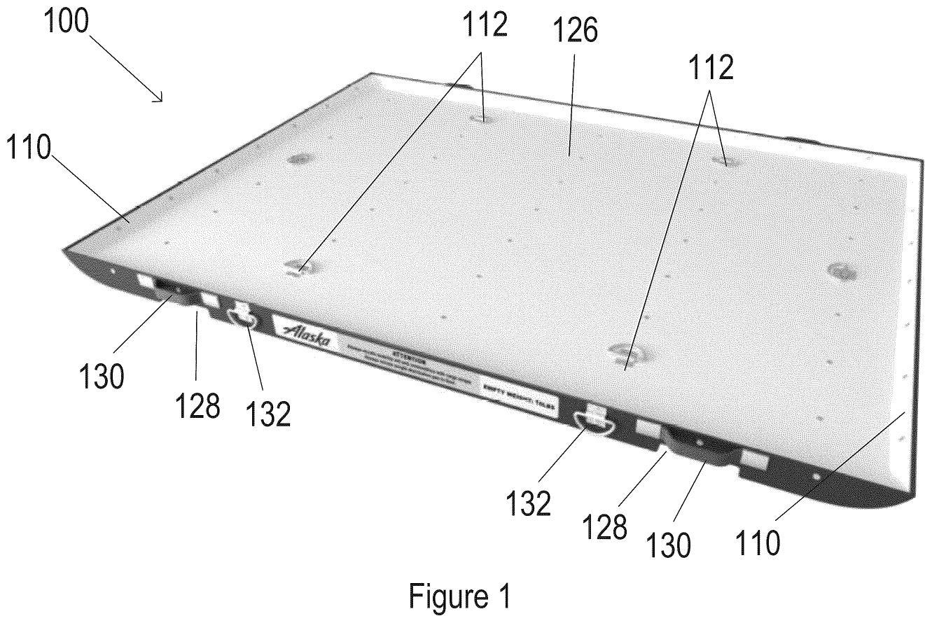

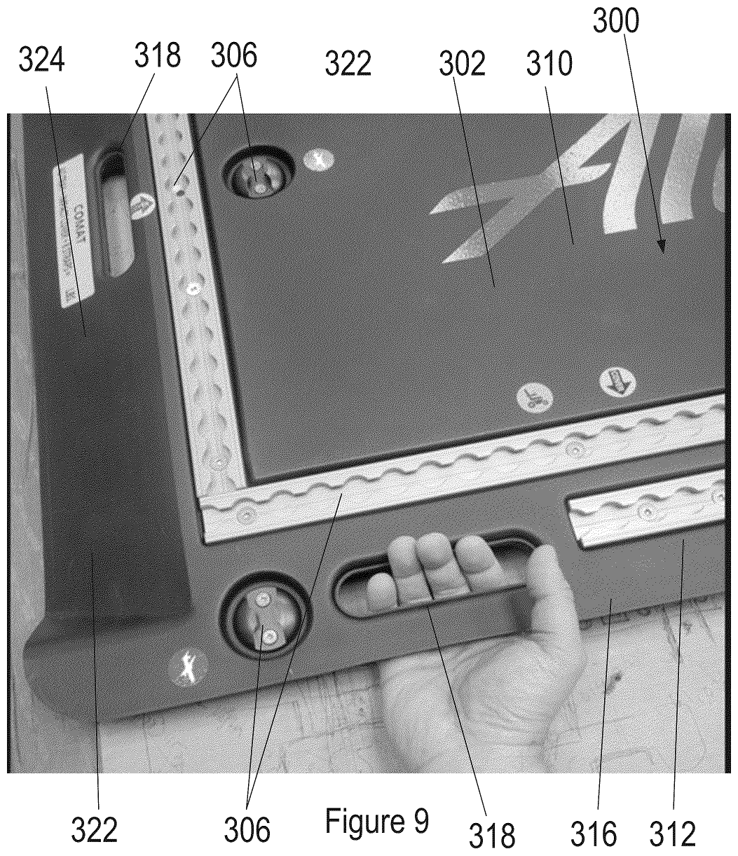

The present technology is directed to a rigid transport assembly for electric wheelchairs, mobility scooters, other mobility aides or other heavy items to provide for secure and safe transport while also providing a weight distribution transport assembly for better weight distribution on the floor of an aircraft or other cargo transport vehicle. The assembly is configured to securely retain heavy mobility aide or other cargo items and to distribute the load or forces (lbs./ft²) across a larger area of the cargo floor while securely holding and protecting the mobility aide or other cargo items from movement or potential damage in the cargo area of the vehicle during transport. Specific details of the present technology are described herein with reference to FIGS. 1-12. Although one or more embodiments are described with respect to rigid transport assembly for cargo floor weight distribution, it should be noted that other applications and embodiments in addition to those disclosed herein are within the scope of the present technology. Further, embodiments of the present technology can have different configurations, components, and/or procedures than those shown or described herein. Moreover, a person of ordinary skill in the art will understand that embodiments of the present technology can have configurations, components, and/or procedures in addition to those shown or described herein and that these and other embodiments can be without several of the configurations, components, and/or procedures shown or described herein without deviating from the present technology.

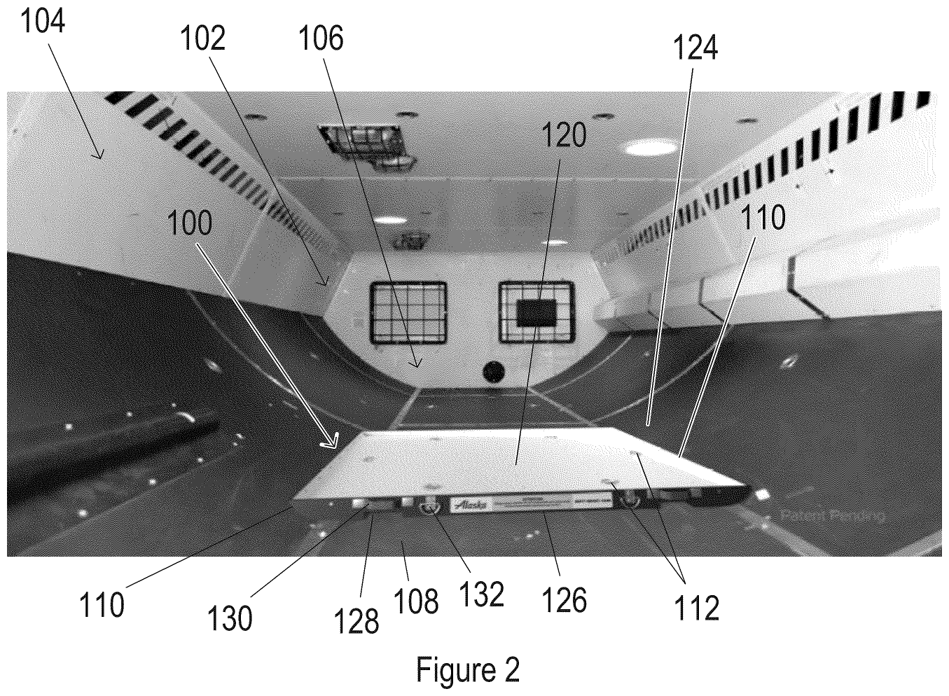

FIGS. 1 and 2 are perspective views of a rigid transport assembly 100 for weight distribution in the cargo pit area 102 (FIG. 2) of an aircraft 104 (FIG. 2) or other cargo transport vehicle in accordance with one or more embodiments of the present technology. The transport assembly 100 is a substantially rigid structure that is shaped and sized to fit in an across the aircraft's cargo pit area 106 so as acts as a cargo floor weight distribution transport structure to securely support and fixedly hold the heavy mobility aide in a safe and fixed position in the cargo area while distributing the weight of the heavy mobility aide over a larger area of the cargo floor panel(s). The heavy mobility aide can include electric wheelchairs, mobility scooters, walkers, power chairs, etc. In the illustrated embodiment, the transport assembly 100 extends across and covers the cargo floor panels 108. Shaped sides 110 of the transport assembly 100 extend at least partially up the side walls of the cargo area, so the transport assembly will not shift laterally. The transport assembly 100 has cargo tie-down hardware 112 to which the selected heavy mobility aide or other suitable cargo can be releasably secured onto the transport assembly 100.

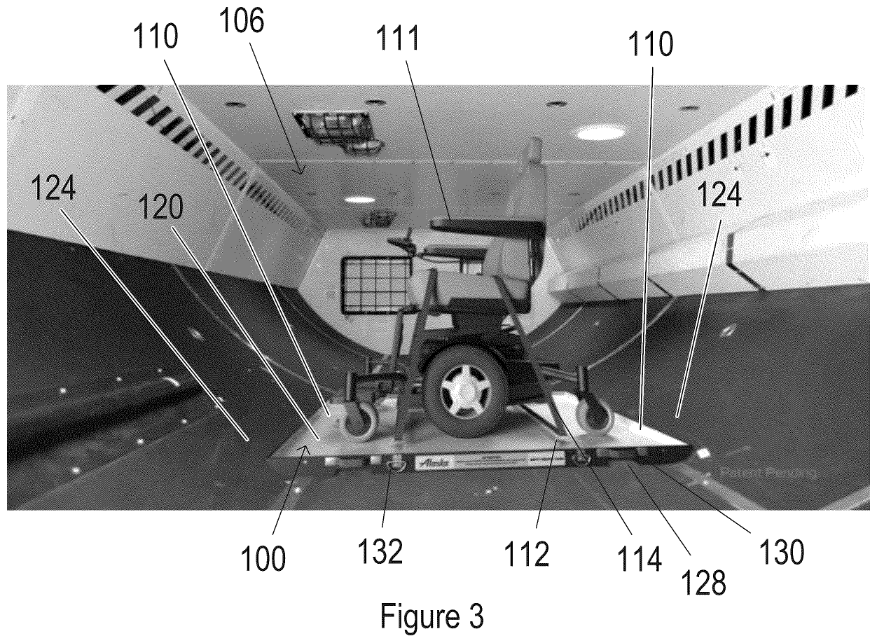

FIG. 3 is a perspective view of the transport assembly 100 of FIG. 2 positioned on the floor of an aircraft's cargo area and with a heavy item, such as a powered mobility aide 111, secured to the cargo tiedown hardware with suitable straps 114 or other retention features. Straps or other retention hardware can also be releasably attached to cargo tiedown hardware on the vehicle's cargo area floor structure so as to securely retain the transport assembly 100 in position within the cargo area. In some embodiments, straps or other tie-down features can interconnect the cargo tie-down hardware of the transport assembly 100 to the cargo tie-down hardware on the cargo area floor panels to securely hold the assembly and its cargo contents in a fixed position within the cargo area. While FIG. 3 illustrates the mobility aide 111 as an electric wheelchair secured atop the transport assembly 100, other heavy mobility aides or other cargo items can be affixed atop the transport assembly 100. As a result, the loaded transport assembly 100 distributes the load of the heavy cargo item across a larger area of the cargo area's floor panels. Accordingly, the weight per unit area, such as lbs./ft², applied to the floor panels is lower and can be maintained below weight limit thresholds for the aircraft's cargo area.

In the illustrated embodiment, the transport assembly 100 has a base panel 120 shaped and sized to extend across the vehicle's floor of the cargo pit area 106. Shaped sidewalls 110 are integrally or otherwise connected to the base panel 120 and are shaped to extend along at least a portion of the curved sidewalls 124 of the cargo pit area 106. The sidewalls 110 of the illustrated embodiment extend upwardly from the base panel 120 to form a sealed pan structure that can retain solid and fluid materials within the boundary of the transport assembly to reduce leakage onto to the floor or walls of the cargo pit area 106. Different embodiments can have sidewalls of different heights. In some embodiments, some or all of the transport assembly 100 can be made of flame-retardant materials, such as Kydex® T or other plastic or strong, rigid material. The base panel 120 can have a sealed internal structure made of a rigid, yet lightweight honeycomb material. Other embodiments can use other materials.

As seen in FIG. 3, the bottom 126 of the transport assembly 100 faces the floor of the cargo floor. The transport assembly 100 can have recesses or other receiving areas 128 configured to removably receive tines of a forklift or other lifting structure that may be used to move the transport assembly 100 to and/or from the aircraft, as well as into and/or out of the cargo pit area. Exterior handles 130 can be provided on one or more sides of the transport assembly 100, so a user can grasp the handles and move the transport assembly 100 within the cargo pit area 106, such as during loading or unloading of the assembly into the aircraft. In addition, external tiedown hardware 132 can be attached to the transport assembly 100, such as along a sidewall or on the bottom portion adjacent to the front or rear edge portions. The external tiedown hardware 132 can be removably coupled to structural anchors in the floor or other structural components in the cargo pit areas, thereby releasably securing the transport assembly 100 in a selected position within the cargo pit area 106 and distributing the weight of the heavy mobility aide (or other cumbersome, heavy cargo items) over a larger area of the cargo area floor panels.

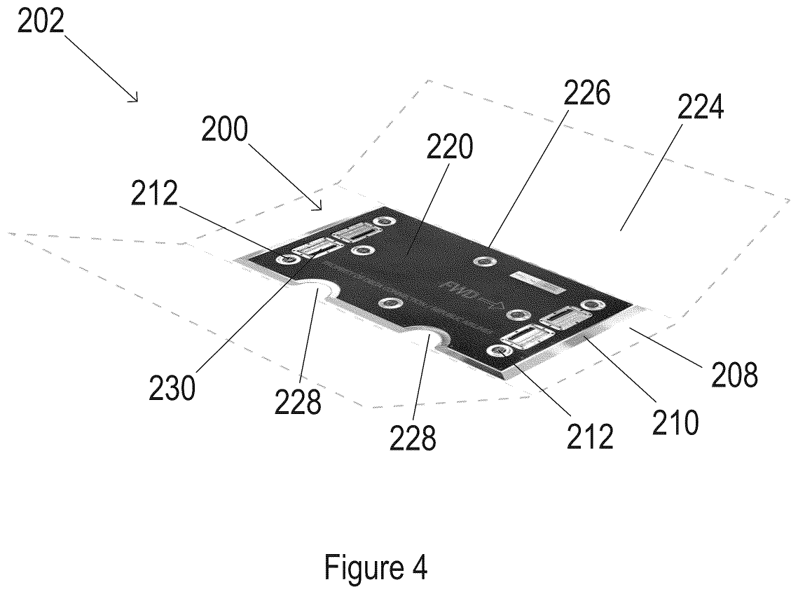

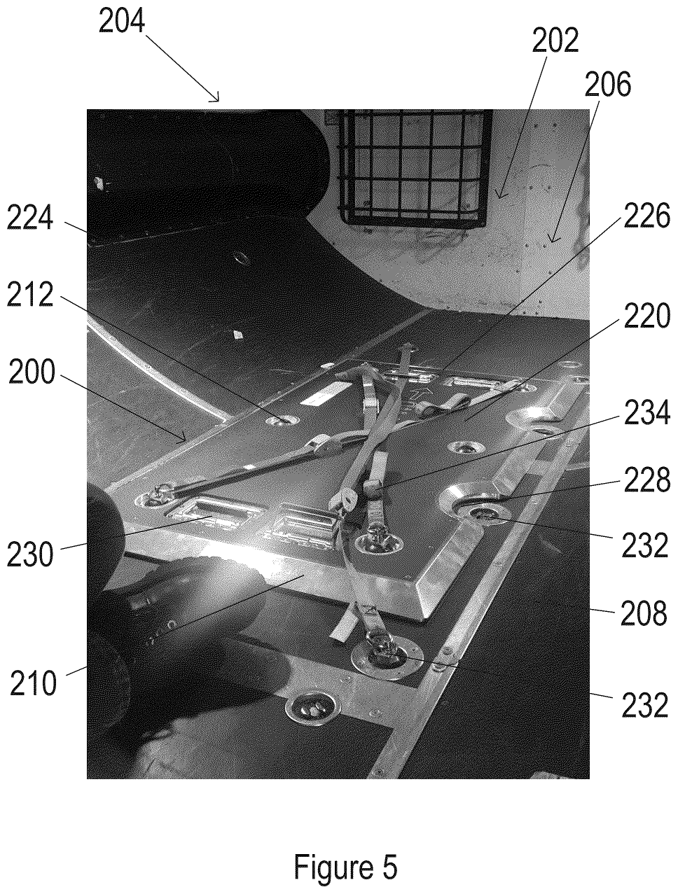

FIGS. 4 and 5 are perspective views of another transport assembly 200 for use in the cargo area 202 of an aircraft 204 (FIG. 5) or other cargo transport vehicle in accordance with one or more embodiments of the present technology. The transport assembly 200 is a substantially rigid structure that is shaped and sized to fit in the aircraft's cargo pit area 206. In the illustrated embodiment, the bottom 226 of the transport assembly 200 faces the cargo floor panels 208. The transport assembly 200 has cargo tie-down hardware 212 to which straps 234 (FIG. 5) couple in order to releasably secure selected cargo onto the transport assembly 200. The straps 234 also couple to cargo tie-down hardware 232 on the cargo floor panels 208 such that the transport assembly 200 is positioned between the selected cargo and the cargo floor panels 208 instead of directly coupled to the cargo floor panels 208. The transport assembly 200 of the illustrated embodiment includes D-shaped cutouts 228 that extend around and expose the cargo tie-down hardware 232 on the cargo floor panels 208. The cutouts 228 allow the straps 234 to couple to the cargo tie-down hardware 232 on the cargo floor panels 208 while maximizing the area of the base panel 220. The shape, size, and location of the cutouts 228 can be specific to an aircraft model. Different embodiments of the transport assembly 200 can have different dimensions.

A ramped frame 210 extends around the perimeter of the transport assembly 200 to protect the sides of the transport assembly 200. Different embodiments of the ramped frame 210 can be made of a rigid, durable material, such as Aluminum or other suitable metallic or non-metallic substantially rigid material. The frame 210 can have different shapes and sizes, such as to correspond to the size and/or shape of a vehicle's cargo hold area in which the assembly can be used. In some embodiments, the transport assembly 200 does not include the ramped frame 210.

The transport assembly 200 also includes handles 230 that assist with the lifting and transportation of the transport assembly 200. The handles 230 can be provided by handle hardware with a portion that is movable between a flat, stowed position and a raised, deployed position. For example, the handles 230 can be biased toward the stowed position to lay flat and be flush with the base panel 220 via torsional springs or other biasing member to prevent the handles 230 from interfering with, for example, loading of selected cargo onto the transport assembly 200. The handles 230 can be moved to the raised, deployed position so the handles are in a generally upright orientation so a user can grasp and hold the handles 230 to lift or otherwise move and position the transport assembly 200. In other embodiments, the handles 230 can be formed by other configurations, such as integrally formed protruding handle structures of via apertures that form a grasping area defining the handle.

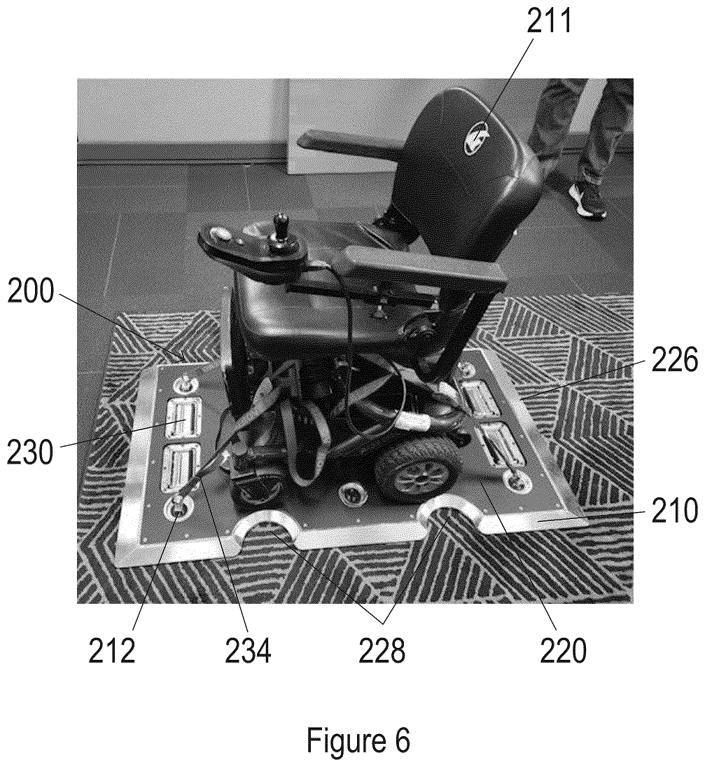

FIG. 6 is a perspective view of the transport assembly 200 of FIG. 4 positioned on a floor with a heavy item, such as a powered mobility aide 211 secured to the assembly 200 in accordance with one or more embodiments of the present technology. The straps 234 are coupled to the cargo tie-down hardware 212 of the transport assembly 200 and wrap around and/or over the mobility aide 211. Straps 234 can also be releasably attached to cargo tiedown hardware on the vehicle's cargo area floor so as to securely retain the transport assembly 200 in position within the cargo area. In some embodiments, straps or other tie-down features can interconnect the cargo tie-down hardware 212 of the transport assembly to the cargo tie-down hardware on the cargo area floor panels to securely hold the assembly and its cargo contents in a fixed position within the cargo area. While FIG. 6 illustrates the mobility aide 211 as an electric wheelchair secured atop the transport assembly 200 via straps 234, other heavy mobility aides or other cargo items can be affixed atop the transport assembly 100. As a result, the loaded transport assembly 200 distributes the load of the heavy cargo item across a larger area of the floor. Accordingly, the weight per unit area, such as lbs./ft², applied to the floor is lower and can be maintained below weight limit thresholds of, for example, the aircraft's cargo area 202 (FIG. 5).

In some embodiments, the base panel 220 and the bottom 226 can be made of Kydex® T or another plastic or rigid material. The base panel 220 and the bottom 226 sandwich and protect an inner core board, which can be made of Alclad plywood, conventional plywood, or a composite material. Other embodiments can use other materials.

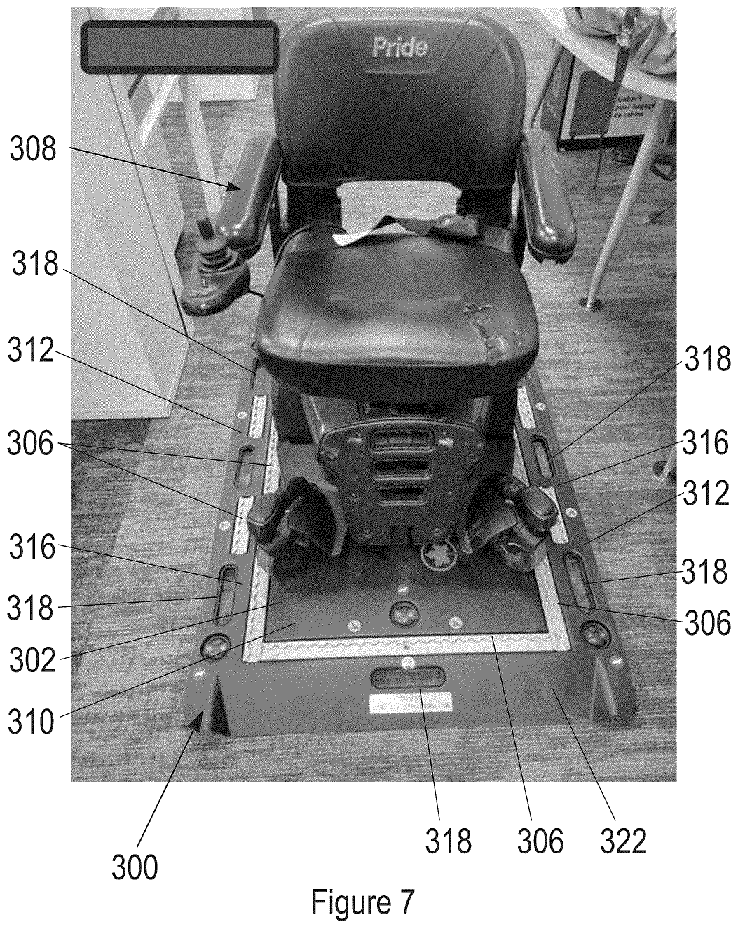

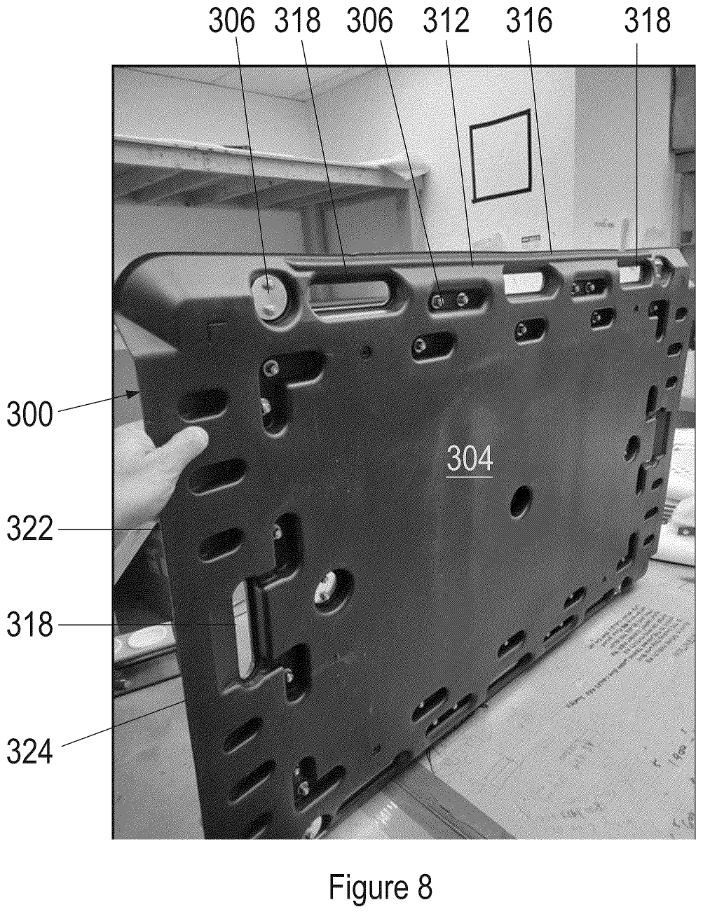

FIG. 7-9 are perspective views of another transport assembly 300 for use in a cargo area of an aircraft or other cargo transport vehicle in accordance with one or more embodiments of the present technology. The transport assembly 300 is a substantially rigid structure that is shaped and sized to fit in the aircraft's cargo pit area 102 (FIG. 2). In the illustrated embodiment, the top 302 of the transport assembly 300 faces upwardly away from the cargo floor panels, and the bottom 304 (FIG. 8) of the transport assembly 300 faces toward the cargo floor panels. The transport assembly 300 has cargo tie-down hardware 306 to which straps 114 (FIG. 3) are releasably coupled in order to secure selected mobility aides 308 or other heavy cargo onto the transport assembly 300. The straps 114 also couple to cargo tie-down hardware on the cargo floor panels of the aircraft or other vehicle such that the transport assembly 300 positioned between the selected cargo and the cargo floor panels instead of directly coupled to the cargo floor panels.

The transport assembly 300 of the illustrated embodiment has a central base panel 310 shaped and sized to extend across the vehicle's floor of the cargo pit area 106 (FIG. 2). Shaped sidewall portions 312 are integrally or otherwise connected to the base panel 310 and are shaped to extend adjacent to at least a portion of the curved sidewalls 124 of the cargo pit area 106 (FIG. 2). The sidewall portions 312 extend upwardly from the floor panels of the cargo area, so an outer engaging portion 316 of the sidewall portions 312 are spaced above and apart from the cargo floor panels. The outer engaging portions 316 of the illustrated embodiment have integral handles 318 configured to allow a user to grasp the handles and move or guide the transport assembly 300 during use. In the illustrated embodiment, the handles 318 are formed by shaped apertures in the outer engaging portions 316. In other embodiments, the handles 318 can be provided by handle hardware attached to the outer engaging portions.

The transport assembly 300 of the illustrated embodiment also has end walls 322 coupled to the base panel 310 and extending between the sidewall portions 312 and positioned to be substantially perpendicular to the wall panels of the cargo area. At least one of the end walls has a ramp configuration 324 sloping downwardly from the top of the base panel 310. One or more of the end walls 322 can include a handle for engagement by a user. Different embodiments can have end walls and sidewalls of different heights or shapes.

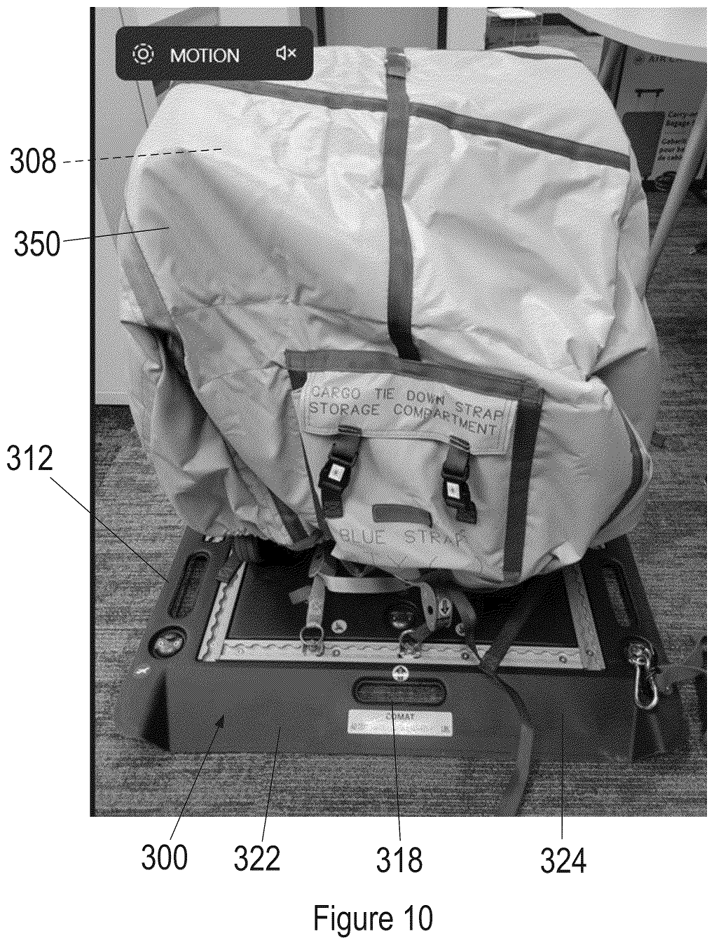

FIG. 10 is a perspective view of the transport assembly 300 of FIG. 7 with a heavy mobility 308 strapped atop the assembly 300 and a cover 350 over the mobility aide 308. The cover 350 is configured to help protect the mobility aide 308 from impact or from potential damage during transport while securely strapped or otherwise attached to the transport assembly 300. The cover 350 of the illustrated embodiment has tie-down features 352, such as straps, D-rings, hooks, anchors or other structures that can releasably attached to the tie-down hardware 306 coupled to the base panel 310, the sidewall portions 312, and/or the end walls 322.

FIGS. 11 and 12 are perspective views of the transport assembly 300 of FIG. 7 with a heavy mobility aide 360 strapped atop the transport assembly 300. In FIG. 11, the mobility aide 360 is uncovered, and in FIG. 12 the mobility aide 360 is within a cover 350 secured to the transport assembly's tie-down hardware 306. In this illustrated embodiment, the transport assembly 300 includes supplemental handles 370 coupled to the base panel 310. The supplemental handles 370 cand be removably attached to the tie-down hardware 306 via retention clips or the like as shown in FIGS. 11 and 12. In other embodiments, the supplemental handles can be essentially non-removable. The supplemental handles 370 provide additional structure that a user can grasp or access, such as during loading, unloading, or moving the transport assembly into or out of the cargo area.

From the foregoing, it will be appreciated that specific embodiments of the invention have been described herein for purposes of illustration, but that various modifications may be made without deviating from the scope of the invention. Accordingly, the invention is not limited except as by the appended claims.

It will be apparent to those having skill in the art that changes may be made to the details of the above-described embodiments without departing from the underlying principles of the present disclosure. In some cases, well known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Throughout this disclosure, the singular terms “a,” “an,” and “the” include plural referents unless the context clearly indicates otherwise. Additionally, the term “comprising,” “including,” and “having” should be interpreted to mean including at least the recited feature(s) such that any greater number of the same feature and/or additional types of other features are not precluded.

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

The disclosure set forth above is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

I claim:

1. A mobility aide transport assembly for use in a cargo hold of a transport vehicle, wherein the cargo hold has curved wall panels, floor panels extending between the curved wall panels, and anchor members, the assembly, comprising:
a base panel having opposed top and bottom portions, the bottom portion configured to face the floor panels of the cargo hold and the top portion configured to support a heavy mobility aide;
sidewalls coupled to the base panel and shaped to extend along and up at least a portion of the curved wall panels of the cargo hold, wherein the sidewalls are coplanar with or extend above the top surface to form platform arrangement that can retain solid and fluid materials within the boundary of the base panel;
a plurality of first tie down anchors coupled to the top portion of the base panel and configured to releasably engage tiedown strap connected to the heavy mobility aide to fixedly retain the heavy mobility aide atop the base panel;
a plurality of second tie down anchors coupled to the base panel and configured to connect to connection members connected to the anchor members of the cargo hold to releasably retain the base panel in a fixed position relative to the cargo hold's floor panels; and
a plurality of handles coupled to the base panel and configured to be engaged by a user to position the base panel relative to the cargo hold's floor panels;
wherein the base panel is configured to distribute weight of the heavy mobility aide across the area of the panels bottom portion for reduction of the load (lbs/ft²) to the cargo hold's floor panels supporting the cargo floor weight distribution transport assembly and the heavy mobility aide.

2. The mobility aide transport assembly of claim 1 wherein the bottom portion of the base panel has integral receiving areas configured to removably receive tines of a lifting assembly used move the cargo floor transport assembly into or out of the cargo hold.

3. The mobility aide transport assembly of claim 1, further comprising opposed end walls coupled to the base panel and extending between the sidewalls, and the handles are attached to the end walls.

4. The mobility aide transport assembly of claim 1 wherein the handles are attached to the top portion of the base panel.

5. The mobility aide transport assembly of claim 1 wherein the handles are at least partially recessed in the top portion of the base panel and are movable between a stowed position generally flat with the base panel and a raised, deployed position projecting upwardly from the base panel.

6. The mobility aide transport assembly of claim 5, wherein the handles are biased toward the stowed position.

7. The mobility aide transport assembly of claim 1 wherein at least the base panel is made of a rigid, flame-retardant material and has a rigid internal honeycomb configuration.

8. A mobility aide transport assembly for use in a cargo hold of a transport vehicle, wherein the cargo hold has wall panels, floor panels extending between the wall panels, and floor anchor members, the assembly, comprising:
a base panel having opposed top and bottom portions, the bottom portion configured to face the floor panels of the cargo hold and the top portion configured to support a mobility aide atop the base panel;
sidewalls coupled to the base panel and shaped to extend adjacent and substantially parallel to the wall panels of the cargo hold;
end walls coupled to the base panel and extending between the sidewalls and substantially perpendicular to the wall panels of the cargo area, wherein at least one of the end walls has a ramp configuration sloping downwardly from the top portion to the bottom portion of the base panel;
a plurality of first tie down anchors recessed in the top portion of the base panel and configured to releasably engage tiedown strap connected to the mobility aide to fixedly retain the mobility aide atop the base panel;
a plurality of second tie down anchors recessed in the top portion of the base panel and configured to be coupled to the floor anchor members;
a plurality of handles recessed in the top portion of base panel and configured to be engaged by a user to position the base panel relative to the cargo hold's floor panels;
wherein the base panel is configured to distribute weight of the mobility aide transport across the area of the panels bottom portion for reduction of the load (lbs/ft²) to the cargo hold's floor panels supporting the transport assembly and the mobility aide transport.

9. The mobility aide transport assembly of claim 8 wherein the bottom portion of the base panel has integral receiving areas configured to removably receive tines of a lifting assembly used move the transport assembly into or out of the cargo hold.

10. The mobility aide transport assembly of claim 8 wherein the handles are movable between a stowed position generally flat with the top portion of the base panel and a raised, deployed position projecting upwardly from the base panel.

11. The mobility aide transport assembly of claim 8 wherein the handles are recessed in the top portion of the panel adjacent to at least the end walls.

12. The mobility aide transport assembly of claim 8 wherein at least the base panel is made of a rigid, flame-retardant material and has a rigid internal honeycomb configuration.

13. The mobility aide transport assembly of claim 8 wherein the sidewalls and end walls are interconnected to form a sloped frame around the base panel, wherein the slope frame extends downwardly from the top portion to the bottom portion.

14. The assembly of claim 8 wherein the sidewalls and end walls are interconnected to form a shaped aluminum frame around the base panel.

15. The mobility aide transport assembly of claim 8 wherein the sidewalls have integral recesses formed therein and configured to provide access to the floor anchor members of the floor panels.

16. The mobility aide transport assembly of claim 8, further comprising a plurality of first anchor straps releasably couplable to the first tie down anchors and to the heavy cargo item to securely affix the heavy cargo item atop the base panel.

17. The mobility aide transport assembly of claim 16, further comprising a plurality of second anchor straps releasably couplable to the floor anchor and to either the first tie down anchors or to the heavy cargo item.

18. A cargo floor weight distribution transport assembly for use in a cargo hold of a transport vehicle, wherein the cargo hold has wall panels, floor panels extending between the wall panels, and floor anchor members, the assembly, comprising:
a base panel having opposed top and bottom portions, the bottom portion configured to face the floor panels of the cargo hold and the top portion configured to support a heavy cargo item atop the base panel;
sidewalls coupled to the base panel and shaped to extend adjacent and substantially parallel to the wall panels of the cargo hold;
end walls coupled to the base panel and extending between the sidewalls and substantially perpendicular to the wall panels of the cargo area;
a plurality of tie down anchors recessed in the top portion of the base panel and configured to releasably engage tiedown strap connected to the heavy cargo item to fixedly retain the heavy cargo item atop the base panel;
a plurality of handles recessed in the top portion of base panel and configured to be engaged by a user to position the base panel relative to the cargo hold's floor panels;
wherein the base panel is configured to distribute weight of the heavy cargo item across the area of the panels bottom portion for reduction of the load (lbs/ft²) to the cargo hold's floor panels supporting the cargo floor weight distribution transport assembly and the heavy cargo item.
